(19) United States
(12) Patent Application Publication
(10) Pub. No.: US 2026/0046302 A1
(43) Pub. Date: Feb. 12, 2026

(54) ADAPTIVE RESOURCE AND SECURITY OPTIMIZATION FRAMEWORK FOR MACHINE LEARNING AS A SERVICE SYSTEMS

(71) Applicant: Cisco Technology, Inc., San Jose, CA (US)

(72) Inventors: Akram Sheriff, Newark, CA (US); Mahesh Viswanathan, White Plains, NY (US); Ramin Pishehvar, La Crescenta, CA (US)

(73) Assignee: Cisco Technology, Inc., San Jose, CA (US)

(21) Appl. No.: 19/092,002

(22) Filed: Mar. 27, 2025

Related U.S. Application Data
(60) Provisional application No. 63/679,824, filed on Aug. 6, 2024.
(60) Provisional application No. 63/679,838, filed on Aug. 6, 2024.

(51) Int. Cl. H04L 9/40; H04L 41/16

(52) U.S. Cl. CPC H04L 63/1433; H04L 41/16

(57) ABSTRACT

In one implementation, a device converts tokens in payloads for processing by an artificial intelligence model over time into vector embeddings. The device tracks, using the vector embeddings, a feature significance for each of a set of model features used by the artificial intelligence model to process the payloads. The device identifies a particular feature in the set of model features whose feature significance has dropped below a threshold. The device redeploys the artificial intelligence model with a reduced feature set that excludes the particular feature.

### RELATED APPLICATIONS

This application claims priority to U.S. Provisional Application No. 63/679,824, filed Aug. 6, 2024 and entitled “ADAPTIVE RESOURCE AND SECURITY OPTIMIZATION FRAMEWORK FOR MACHINE LEARNING AS A SERVICE SYSTEMS” by Sheriff, et al., as well as to U.S. Provisional Application No. 63/679,838, filed Aug. 6, 2024 and entitled “DATA QUALITY OBSERVABILITY FOR RETRIEVAL AUGMENTED GENERATION-BASED GENERATIVE ARTIFICIAL INTELLIGENCE” by Sheriff, the contents of both of which are incorporated herein by reference.

### TECHNICAL FIELD

The present disclosure relates generally to computer networks and more particularly to adaptive resource and security optimization framework for machine learning as a service (MLaaS) systems.

### BACKGROUND

Machine learning (ML) and artificial intelligence (AI) are emerging as focal components of modern data-driven applications, especially in cloud environments. These technologies rely on complex data pipelines for training models and making predictions. As these models are deployed at scale they must handle vast amounts of data, requiring robust and efficient infrastructure to ensure low-latency and high-throughput performance.

Currently, the predominant focus in the ML deployment paradigm is on training models to enhance their accuracy and performance. However, in production environments, the primary costs and challenges shift towards managing the runtime execution and inference of these models. High-volume applications, such as voice assistants and other real-time services, demand significant computing resources, leading to substantial operational expenses and complexity in cloud resource management.

The existing methodologies for deploying ML models in cloud platforms like AWS, GCP, and Azure lack automated solutions for optimizing resource utilization, ensuring data quality, and preventing security threats. Without tools to detect and eliminate non-essential features, the cloud infrastructure can become inefficient, driving up operational costs. Additionally, the absence of mechanisms to validate incoming data payloads exposes systems to potential security vulnerabilities and the risk of false data influencing model performance. This inefficiency can result in unnecessary model retraining, wasted computational resources, and increased operational costs.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of an architecture for machine learning as a service;

FIG. 4 illustrates an example of an architecture for real-time assessment of resource utilization and security threats in a cloud-based ML environment;

FIG. 5 illustrates an example of a procedure of dimensionality reduction applied to word embeddings;

FIG. 6 illustrates an example of a MLOps workflow lifecycle;

FIG. 7 illustrates an example of a table representing a real-time analysis of feature priority;

FIG. 8 illustrates an example of a graph showing feature importance from a tree-based machine learning model;

FIG. 9 illustrates an example of a graph of the monitoring of feature significance over time and detecting anomalous events or deviations;

FIG. 10 illustrates an example of table of resource savings for adaptive resource and security optimization framework for machine learning as a service systems;

FIG. 11 illustrates an example of a workflow for automated identification of which data/data sources are providing incorrect information at the source of a retrieval augmented generation data pipeline;

FIGS. 12A-12B illustrate an example of adding context to a raw dataset to generate a contextualized dataset;

FIG. 13 illustrates an example of a procedure for adding domain-specific context at the data source and using the context to automatically derive a chunk score;

FIG. 14 illustrates an example of a data pipeline with observability operations underscoring how the scoring is done to detect and/or flag issues in an automated manner;

FIGS. 15A-15B illustrates examples of metadata policies providing a framework for managing and monitoring data quality and system performance in a retrieval augmented generation pipeline;

FIG. 16 illustrates an example of a user interface for retrieval augmented generation-based data corruption detection, chunk score derivation, and automated data cleaning pipelines; and

FIG. 17 illustrates an example procedure for adaptive resource and security optimization in MLaaS systems, in accordance with one or more implementations described herein.

### DESCRIPTION OF EXAMPLE IMPLEMENTATIONS

### Overview

According to one or more implementations of the disclosure, a device converts tokens in payloads for processing by an artificial intelligence model over time into vector embeddings. The device tracks, using the vector embeddings, a feature significance for each of a set of model features used by the artificial intelligence model to process the payloads. The device identifies a particular feature in the set of model features whose feature significance has dropped below a threshold. The device redeploys the artificial intelligence model with a reduced feature set that excludes the particular feature.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

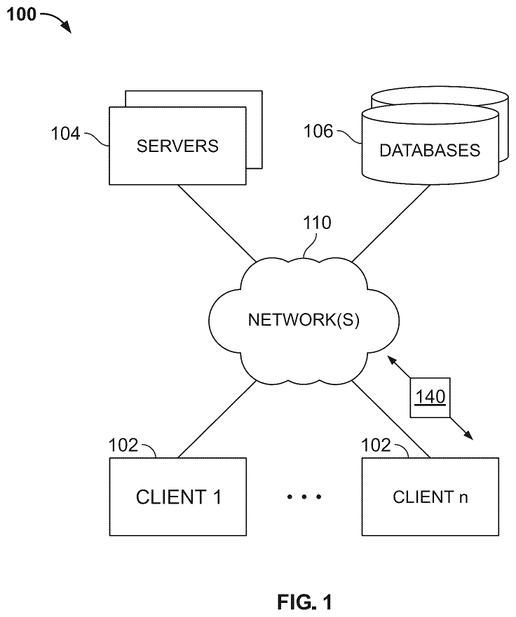

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

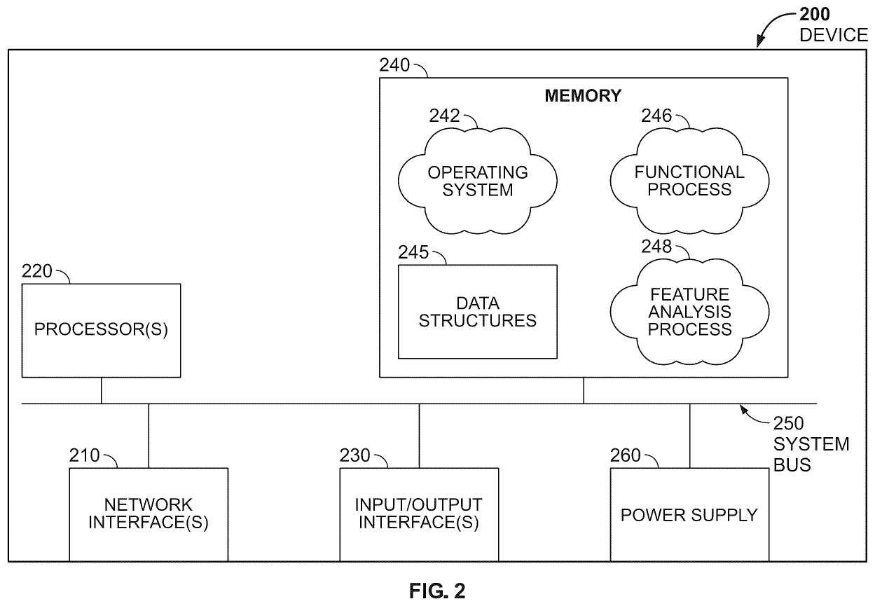

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes (e.g., functional processes 246), and on certain devices, an illustrative process such as feature analysis process 248, as described herein. Notably, functional processes 246, when executed by processor 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, feature analysis process 248 may include computer executable instructions that, when executed by processor 220, cause device 200 to perform the techniques described herein. To do so, in some implementations, feature analysis process 248 may utilize artificial intelligence/machine learning (AI/ML). In general, AI/ML is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, feature analysis process 248 may use one or more supervised, unsupervised, or semi-supervised machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that the feature analysis process 248 can use may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, feature analysis process 248 may also use one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of adaptive resource and security optimization for machine learning as a service (MLaaS) systems, feature analysis process 248 may be a component of, use, and/or be utilized in the management of prompts/access to a generative model configured to perform resource utilization assessment, security threat assessment, cloud resource optimization, data quality assessments, threat protection, etc. based on a conversational input from a user (e.g., voice, text, etc.). Example generative approaches can include, but are not limited to, generative adversarial networks (GANs), large language models (LLMs), other transformer models, and the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

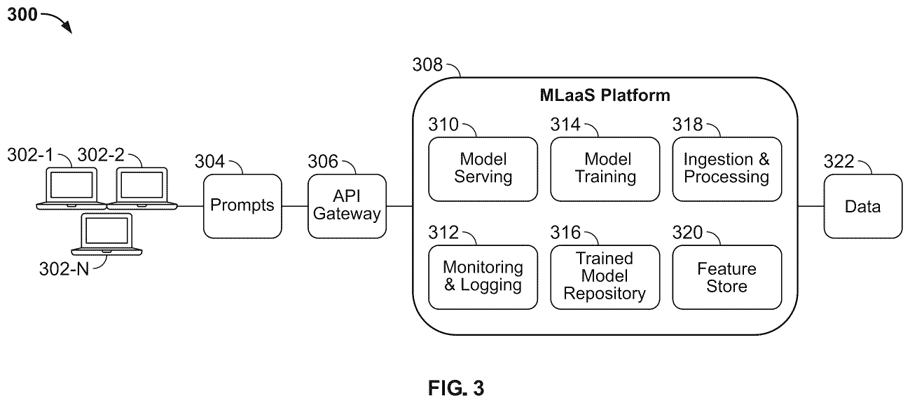

FIG. 3 illustrates an example of an architecture 300 for machine learning as a service (MLaaS) to which an adaptive resource and security optimization framework may be applied, in various implementations. Architecture 300 may include client devices 302 (e.g., 302-1 . . . 302-N). The client devices 302 may be smartphones, web applications, IoT devices, etc. These devices may send prompts 304 to the MLaaS platform 308 via an API gateway 306. The prompts 304 may represent the input data or queries from client devices 302 to be processes by the MLaaS platform 308.

The API gateway 306 may serve as the entry point for all incoming data and requests from client devices 302. It may route these requests to the appropriate component within the MLaaS platform 308 for further processing and/or prediction.

The MLaaS platform 308 may include one or more of a data ingestion and processing component 318, a feature store 320, a model training component 314, a trained model repository 316, a model serving component 310, and/or a monitoring and logging component 312. The data ingestion and processing component 318 may be responsible for collecting, preprocessing, and transforming raw data into a suitable format for further analysis. The feature store 320 may serve as a centralized repository for storing and managing features. It may include components for monitoring, transformations, storage, serving, and registry.

The model training component 314 may use the processed data and features to develop and train machine learning models. Once training is complete, the trained models may be stored in the trained model repository 316. The trained model repository 316 may hold all trained models, making them readily available for deployment and serving. Models from this repository may be accessed by the model serving component 310 to provide predictions.

The model serving component 310 may deploy trained machine learning models and handle incoming prediction requests. It may use the models stored in the trained model repository 316 to generate predictions based on new input data from client devices via the API gateway 306. The monitoring and logging component may continuously track the performance and/or health of the entire MLaaS platform. It may collect logs and metrics from data ingestion and processing component 318, feature store 320, model training component 314, and model serving component 310 to ensure that the system is operating efficiently and securely.

Architecture 300 may include data 322. Data 322 may be the raw data that is ingested and processed by the MLaaS platform 308 to generate features for model training and serving. The adaptive resource and security optimization framework can be integrated into this architecture 300 to enhance resource utilization, ensure data quality, and increase security, thereby optimizing overall performance and cost-effciency.

As noted above, presently, most of the cost (e.g., time and money) associated with the existing cloud-based machine-learning platform (e.g., AWS Sagemaker, etc.) data pipelines paradigm is spent on training ML models to become better. However, as ML models are deployed at scale, most costs will be associated with running the models and doing inference. Production applications can generate millions of predictions per hour, requiring very low-latency and high-throughput networking. For example, Alexa receives millions of requests every minute, accounting for forty percent of all computing costs.

Further, there are no existing mechanisms to optimize cloud resource utilization in this context. However, when deploying a trained machine learning (ML) model as a serving endpoint in a production cluster using model server frameworks (e.g., Seldon Core on Benton, KFServing in a Kubeflow-based MLOps/AIOps environment, etc.), it may be valuable to monitor the data ingested into the model for prediction to optimize resource utilization.

Unfortunately, there are currently no solutions or tools for automatically detecting and eliminating unimportant features for efficient and automated cloud resource utilization. Cloud tools like AWS, GCP, and Azure do not currently offer functionality to allocate resources automatically such as by eliminating unimportant features based on historical feature significance. For example, a set of features may be important at the beginning but lose their significance over time.

Furthermore, there are no existing mechanisms for data quality, security threat detection, and/or resource optimization in cloud within this context. That is, for models that are exposed to public access, it may be valuable to ensure security measures are in place to prevent hackers from sending biased data that can mislead the prediction, causing the model to falsely drift in performance over time.

If a data payload contains junk or intentionally manipulated threats, it can lead to unwanted scenarios such as increased cloud computation costs, falsifying data drift and feature significance shift, which can result in unnecessary model retraining and evaluation, wasting valuable time and resources. There are currently no solutions to detect a valid set of features in a payload before it goes into the model for prediction to ensure “no garbage in, no garbage out” and prevent security threats.

As a result, under the current regime AI/MLOps engineers face a multitude of challenges. First, traditional model endpoints on popular cloud platforms such as AWS, Azure, and GCP do not provide any security checkpoints for incoming HTTPS payloads that go into the model for prediction. As a result, a public-facing model endpoint on the cloud can be vulnerable to attacks, resulting in system breakdowns and increased cloud operation costs.

Second, these platforms do not provide any solution for identifying data quality in incoming payloads. This can result in false data drift or model performance shift, leading to unnecessary model retraining and increased costs in the cloud. Third, after deploying ML models, there is currently no automated end-to-end solution available for monitoring, flagging, and removing non-significant features from central feature store to ensure optimized cloud resource utilization.

### Adaptive Resource and Security Optimization Framework for Machine Learning as a Service Systems

In contrast, the techniques described herein introduce a feature analysis approach that is able to optimize cloud resource utilization, as well as assess the quality of the data and detect potential threats. By detecting valid features in the incoming data payloads (via HTTPS POST messages) and eliminating unimportant features using an adaptive infra-utilization threshold technique in post-ML model deployment over a period of time, these techniques can allocate resources in an optimum manner, reduce operational costs, and scale. Moreover, these techniques may leverage feature shift analysis to determine a valid payload, where an anomalous feature can be detected and flagged based on its abnormal distribution.

Illustratively, the techniques described herein may be performed by hardware, software, and/or firmware, such as in accordance with feature analysis process 248, which may include computer executable instructions executed by the processor 220 (or independent processor of interfaces 210) to perform functions relating to the techniques described herein.

Specifically, according to various implementations, a device converts tokens in payloads for processing by an artificial intelligence model over time into vector embeddings. The device tracks, using the vector embeddings, a feature significance for each of a set of model features used by the artificial intelligence model to process the payloads. The device identifies a particular feature in the set of model features whose feature significance has dropped below a threshold. The device redeploys the artificial intelligence model with a reduced feature set that excludes the particular feature.

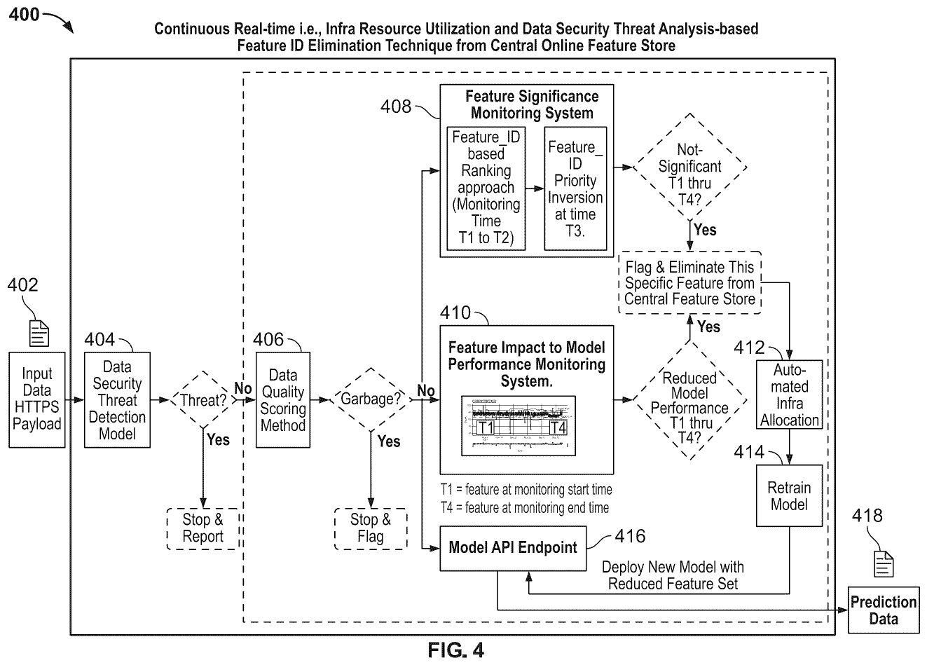

Operationally, FIG. 4 illustrates an example of an architecture 400 for real-time assessment of resource utilization and security threats in a cloud-based ML environment. This architecture 400 addresses the issue of automatically allocating cloud infrastructure based on the elimination of unimportant features from the dataset. Moreover, it provides methods to ensure data quality and detect security threats in incoming HTTPS payloads for public-facing model endpoints.

Architecture 400 may include input data 402. Input data 402 may include incoming data payloads, such as in the form of HTTPS POST messages. The input data 402 may be processed through data ingestion and processing components before it reaches the model prediction stage.

For example, input data 402 may be processed by a data security threat detection component 404. The data security threat detection component 404 may be a model configured to detect any security threats in the payload before it reaches the model prediction stage, maximizing application security, stability, reducing cloud resource utilization cost, and providing uninterrupted customer experience.

The input data 402 may be processed by a data quality scoring component 406. The data quality scoring component 406 may include a method of assessing and/or assigning a characterization of the quality of the data in input data 402. This may include identifying biased or garbage features from the features distribution of a payload as part of data validation process before the model prediction stage. This may avoid unwanted resource usage.

Architecture 400 may include a feature significance monitoring system 408. The feature significance monitoring system 408 may monitor the significance of features over time. It may keep track of feature importance and detect and changes or drift in their relevance to a model's performance. In this manner, when a feature loses significance, it can be flagged and/or eliminated from a central feature store.

In addition, architecture 400 may include a feature impact to model performance monitoring system 410. Feature impact to model performance monitoring system 410 may be operable to assess how different features impact the overall performance of an ML model. It may provide understanding of which features are contributing most to the model's accuracy and efficiency.

In various implementations, architecture 400 may include automated infra-allocation component 412. Automated infra-allocation component 412 may dynamically allocate infrastructure resources based on the feature significance and/or impact analysis. It may adjust the computational resources in real-time to ensure optimized utilization, thereby reducing operational costs and improving scalability.

In architecture 400, when significant changes in feature significance and/or feature impact to model performance are detected, the system may trigger a model retraining process 414. The model API endpoint 416 may serve the trained model for real-time predictions. It may receive the input data 402, processes it using the trained (and/or retrained) model, and return a prediction result 418. The prediction result 418 may include predictions and other relevant data.

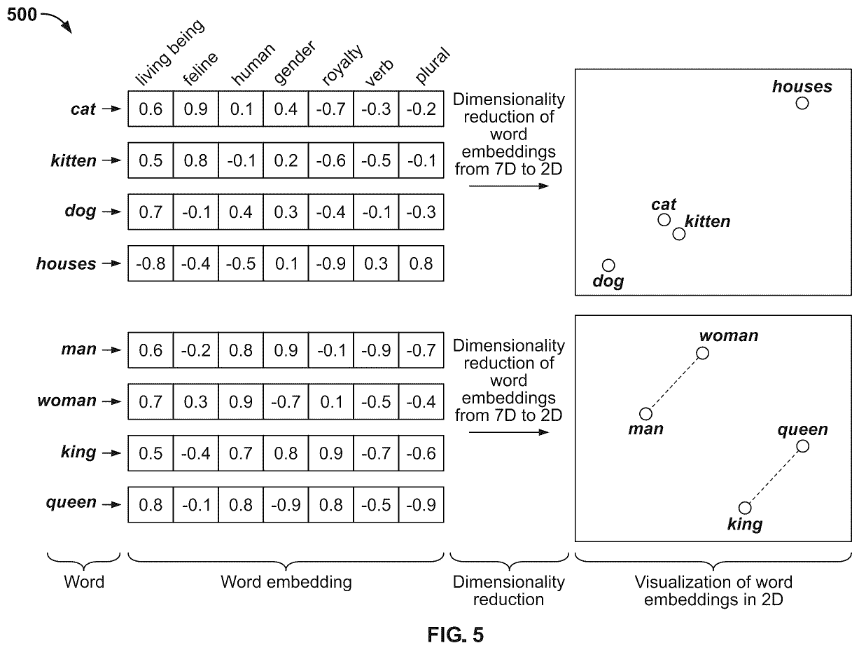

FIG. 5 illustrates an example of a procedure 500 of dimensionality reduction applied to word embeddings and the subsequent visualization of these embeddings in a two-dimensional space. Procedure 500 illustrate how high-dimensional word embeddings may be transformed and visualized for better interpretability and analysis.

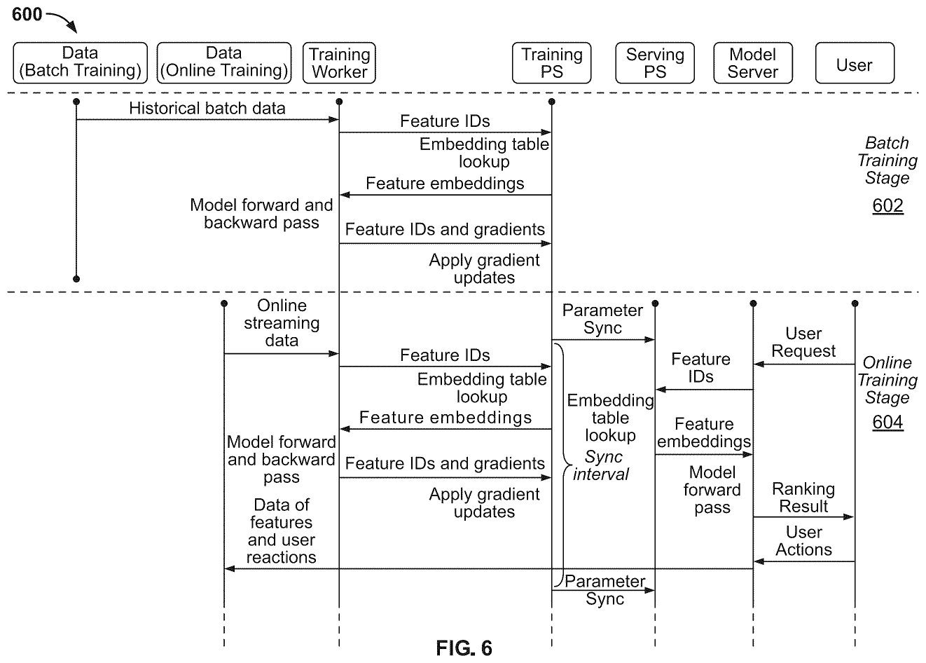

FIG. 6 illustrates an example of a MLOps workflow lifecycle 600. The MLOps workflow lifecycle 600 is illustrated for a batch training stage 602 and an online training stage 604. The MLOps workflow lifecycle 600 may be utilized in digital watermarking of Feature_IDs in a feature table.

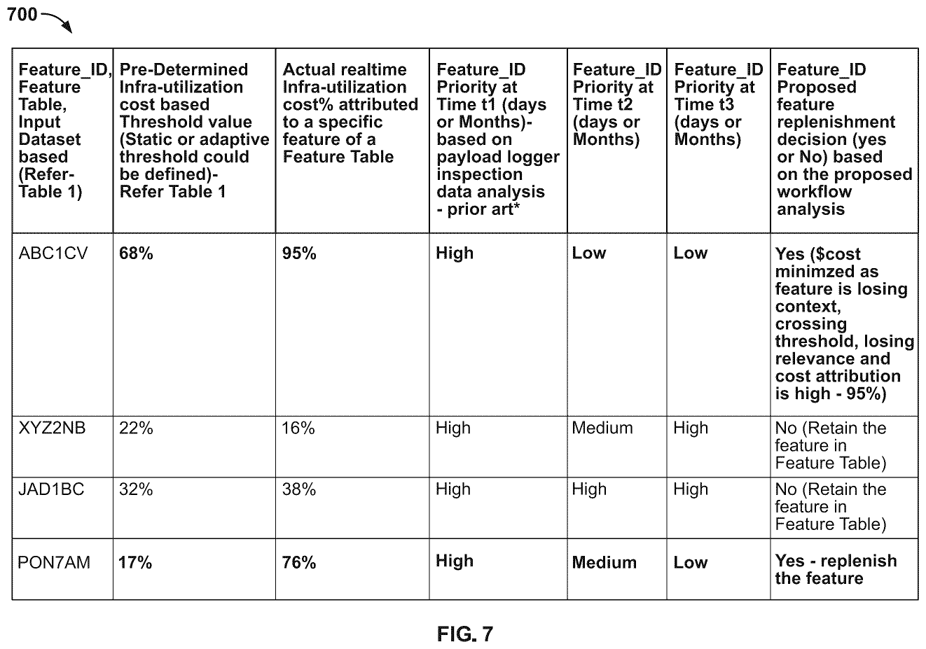

Based on adaptive and/or static pre-defined threshold values (See FIG. 7), a digital watermarking mechanism may be implemented for Feature_IDs which are affected based on the incoming data payloads (e.g., HTTPS POST messages). In various implementations, a key aspect of the digital watermarking of different Feature_IDs may be to eliminate Feature_ID security threat injected into a Feature_Table. Here, the system creates embeddings for different Feature_IDs at T1, T2, . . . , T4 and so on. Of note, the embeddings may facilitate inference of the semantics of the dataset automatically and storing the attributes of the Feature_ID as an embedding structure in a central online feature table in the Cloud PS (Cloud Platform service-Control Plane).

The MLOps workflow lifecycle 600 highlights the incorporation of batch training and online training for digital watermarking of features performed separately so that the Feature_IDs included the central online feature store are robust enough to handle incoming data payload bias, DOS security threats, or other security threat attacks in incoming data payloads.

FIG. 7 illustrates an example of a table 700 representing a real-time analysis of feature priority. Table 700 may illustrate the real time analysis of feature priority for feature replenishment in a centralized online feature table/store based on production serving ML model performance accuracy (e.g., F1 score, classification accuracy) versus pre-determined infra/cost analysis threshold value versus feature priority analysis over a period of time (t).

In various implementations, a data driven analysis of the #Features/Feature Table, #Feature priority, #size of features data in the online feature store may be performed. Then an adaptive threshold in terms of expected infrastructure resource utilization (e.g., CPU, RAM, HDisk) may be derived. To achieve this goal, the system may leverage an adaptive threshold (AT) mechanism, such as [AT=feature significance+data quality score+Anomaly Score+feature impact on model score/CPU+RAM+HDisk], that can effectively identify features with low weightage, which are considered unimportant, garbage, or biased. Once flagged, these features can be removed from a central feature store through an iterative process.

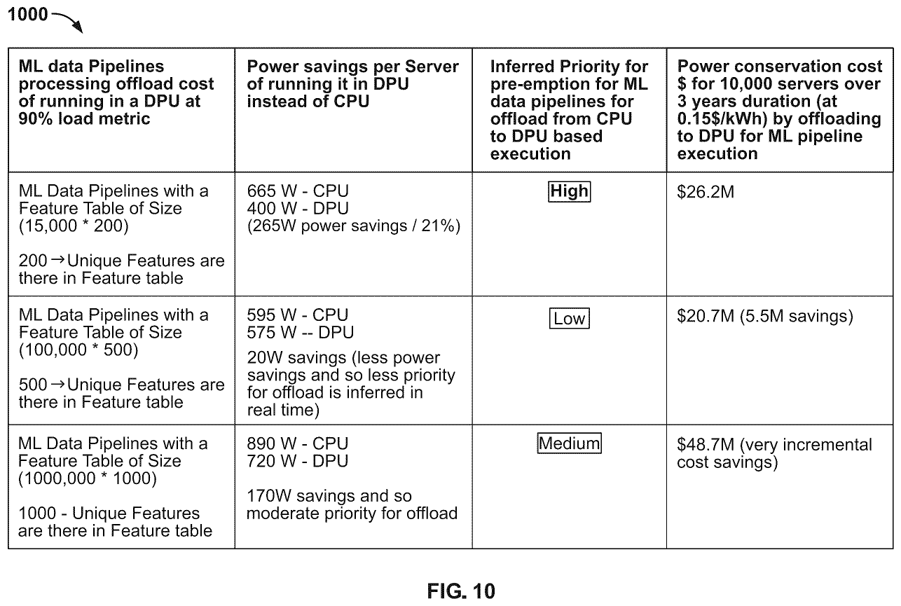

Here, the system may leverage this factual data point to derive an adaptive threshold for acceptable level of infrastructure utilization and its associated resource cost. For example, assume that there is an enterprise use case specific dataset with one thousand five hundred features and one hundred thousand rows. In such a case, “how big is that dataset?”, “how many CPUs/GPUs would it need normally?”, “how much memory is required to do the processing in normal expected traffic volume?”, “how long does it take to train a model?”, etc. Based on the determined answers to these questions, the system can estimate the costs associated with running the inferencing pipeline in a CPU, DPU, or TPU. This value may serve as the baseline and then the system may compare it with the incoming real time traffic to do the multi-level security plus resource utilization analysis, as shown further in FIG. 10.

In various implementations, a resource consumption monitoring-based feature analysis in feature store may be utilized. For instance, the system may use trained models as part of what-if and/or device risk interpretation user interfaces. This may facilitate determining the answer to questions such as: “is the model providing prediction results quickly?”, “if it's becoming slower because of insufficient (CPU, DPU, or TPU) resources or a higher number of incoming requests, can it be flagged in the UI?”, etc. This may allow an admin to allocate more resources for that, or a developer can investigate the reason if it is code/optimization related.

In further implementations, sample ML pipelines data may offload infrastructure/cost analysis for different feature table sizes and for different data set sizes. Based on this analysis the priority for offloading the traffic from CPU to DPU for execution of ML data pipelines or vice versa for pre-empting the traffic may be derived. These two derived values (illustrated in the table 700) may be used in subsequent workflows for doing comparison analysis with different features. This kind of granular infrastructure plus cost analysis-based workflow is not present any other ML pipelines or ML workflow orchestration tools (e.g., Kubeflow, AWS, GCP, Microsoft azure, IBM Watson, Airflow, Openflow, MLflow, etc.). Of note, “High,” “Medium,” and “Low” in table 700 may define the priority for offloading real time traffic in different traffic, feature table, feature sizes as illustrated.

To summarize, the techniques herein propose to derive such a table 700 to show the “infra utilization” during ML training and inference state data pipelines with a first column tagged for CPU, DPU or GPU running particular pipelines (e.g., AWS

Sagemaker pipelines) and then show the resource improvements. Then the static or adaptive threshold value may be derived which can be continuously monitored over a period of time across different feature priorities which are present in a feature table.

As outlined above (e.g., with respect to table 700 in FIG. 7), the techniques described herein may be leveraged to identify specific features from a central online feature store that may be compromised (e.g., infected, affected, etc.) by incoming data payloads (e.g., HTTPS POST messages). These features may be specifically identified and only those affected features may be replenished in the central feature store as part of the workflow. The infra-utilization cost metric/ratio value may be leveraged to perform analysis in real time and then remove only those specific Feature_ID's from feature store.

Further, (e.g., as illustrated by table 700 in FIG. 7) the techniques described herein include identifying specific features that contribute to higher resource infrastructure costs. This identification may be based on the Feature_ID/Infra_cost value for each feature present in the feature table and the percentage of the incoming data payload that affects this resource utilization cost over time.

The data can be plotted graphically in a trendline plot to identify specific features. Ranking these features based on the analysis and creating a workflow for conducting batch training and online training separately for forward pass and backward pass for the specific Feature_IDs may be performed. Even if the Feature_ID priorities change over a period of time with the “Feature_ID inversion” the forward pass and backward pass-based approach may ensure that the “resource cost utilization” remains unaffected in terms of cost due to such Feature_ID priority inversion.

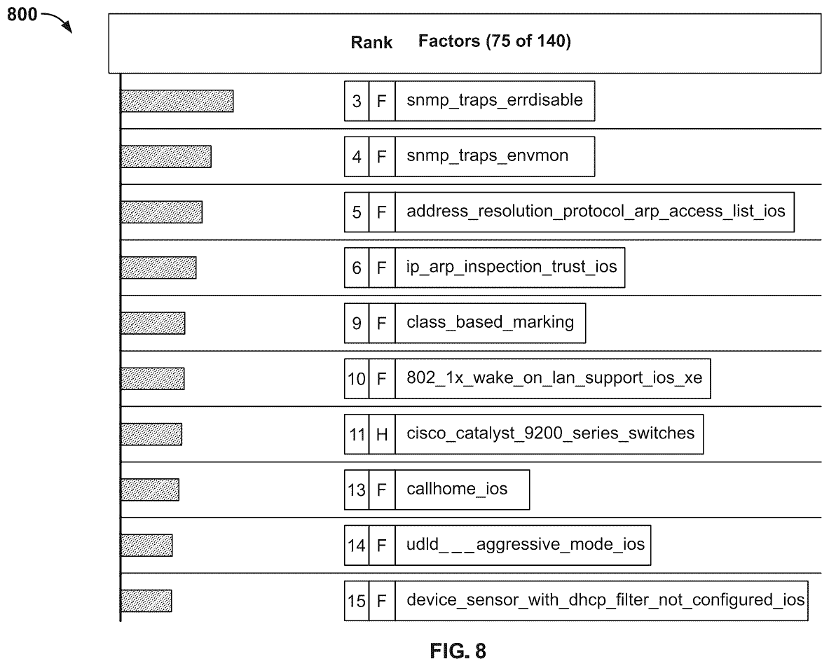

FIG. 8 illustrates an example of a graph 800 showing feature importance from a tree-based ML Model. Here, the feature significance is determined from the feature importance/coefficients of the ML model, which can be monitored over time. A feature may be significant during the model training phase, but over time, data drift can occur, causing the feature to lose its importance after deploying the model. Therefore, post deployment and in the inference layer, it may be necessary to monitor the significance of each feature.

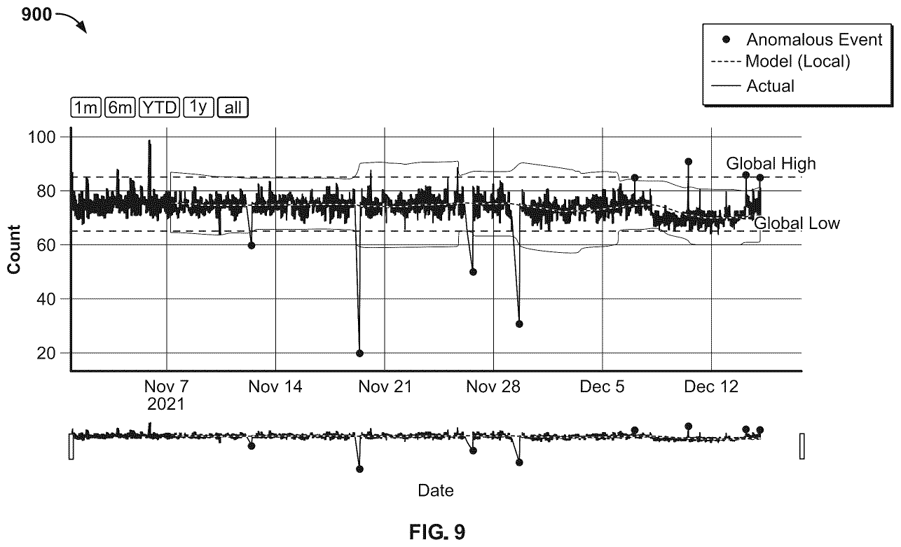

FIG. 9 illustrates an example of a graph 900 of the monitoring of feature significance over time and detecting anomalous events or deviations. The anomalous events on the lower side may be of particular interest as they may indicated that the feature has lost its importance at that point in time.

If and when any feature loses its significance (as per table 700 in FIG. 7 at time T3 and T4 where “ABC1CV” feature is losing its significance) it can be eliminated. Even if a deviation in the significance is detected, the feature and/or its corresponding timestamp may be flagged, and an administrator may be notified. A time-series-based anomaly point detection algorithm, such as a convolution smoother, can be deployed to identify anomalous events in feature significance. The model may take historical feature significance scores and their associated timestamps per feature as inputs and detect anomalous events.

Monitoring and flagging features that are gradually losing their significance over time may be leveraged to automatically allocate resources and scale efficiently. That is, by identifying unimportant features and eliminating them, unnecessary cloud resource usage may be avoided.

FIG. 10 illustrates a table 1000 of example resource savings for adaptive resource and security optimization framework for machine learning as a service (MLaaS) systems. The resource savings may be expressed in terms of power savings, greenhouse gas emission reductions, cost savings, hardware savings, reallocation efficiency gains, or any other metric of operational cost that may be associated with the operation of the model under alternative conditions. In some instances, the table 1000 may include power savings, versus cloud cost-based ML data pipeline offload (e.g., non-significant feature elimination) between CPU and DPU.

It should be noted that while certain steps or components described herein may be optional as described above, the steps and components shown are merely examples for illustration, and certain other steps may be included or excluded as desired. Further, while a particular order or arrangement of the steps and component is shown, this ordering is merely illustrative, and any suitable arrangement of the steps may be utilized without departing from the scope of the implementations herein.

The techniques described herein, therefore, introduce a framework for optimizing machine learning as a service (MLaaS) systems through advanced feature management and resource allocation strategies. In one aspect, this approach provides identification and management of Feature_ID priority and Feature_ID priority inversion, providing a mechanism to continuously identify feature priorities and dynamically adjust models and/or allocation strategies accordingly. Additionally, these techniques introduce a mechanism for identifying security and data bias-related threats via an infra-utilization cost attribution model, offering proactive protection over models and other system components.

Further, the adaptive closed-loop feature significance monitoring system surpasses the capability of available siloed, point-based solutions, ensuring continuous and dynamic feature evaluation. Furthermore, the comprehensive approach offered by these techniques can be utilized to detect, mitigate, and provide actionable recommendations in a closed-loop manner. Moreover, this methodology drastically reduces “Training_Serving_Skew” by eliminating non-significant features.

For example, by normalizing Feature_IDs in relation to infra-resource utilization and Opex costs savings, these workflows enable precise detection, mitigation, and action-taking on feature priorities within a feature store. This may result in substantial operational cost savings and enhanced system performance. These techniques collectively ensure that MLaaS deployments are more secure, cost-effective, and performant, providing a robust solution to the challenges faced in moder machine learning operations.

### Data Quality Observability for Retrieval Augmented Generation-Based Generative Artificial Intelligence

In contrast, the techniques herein introduce a mechanism for assessing and enhancing data quality and contextual accuracy in RAG architectures. The techniques a data contextual awareness mechanism that automatically identifies, sanitized, and corrects specific data elements to prevent stale or corrupted data from entering a RAG pipeline. Further, the techniques introduce a health assessment for each data element that can be leveraged to assess, detect, and address data issues in real-time. These techniques, may ensure that the data used in a retrieval phase is always accurate and relevant, thereby ensuring overall contextual accuracy and retrieval performance.

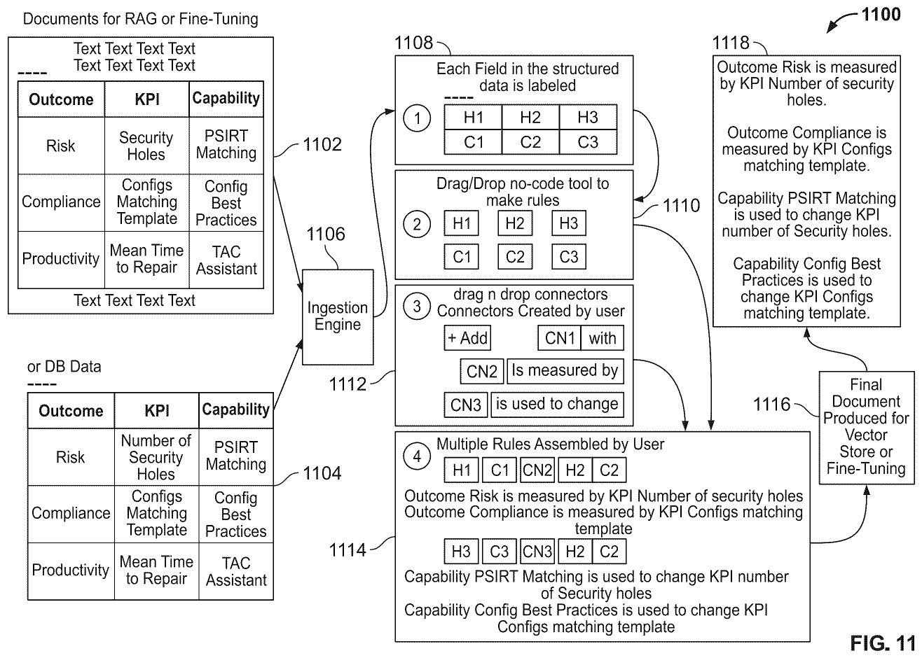

In various implementations, FIG. 11 illustrates an example of a workflow 1100 for determining which specific data, contexts, and therefore which documents, are providing the information that is not correct at the source of a RAG data pipeline in real-time and in an automated manner. Workflow 1100 may be a portion of a data quality assessment process (e.g., feature analysis process 248).

Feature analysis process 248 may leverage workflow 1100 to bring contextual awareness and/or enable automatic identification of which specific data element must be detected, sanitized, and cleaned to ensure stale data does not make its way into a RAG data pipeline which may affect the overall contextual accuracy and/or retrieval accuracy. To do so, workflow 1100 may be operatable in cooperation with and/or as a portion of a mechanism to analyze the data and then derive/create a health score metric based on factors such as data freshness, data Staleness, data lineage patterns, metadata changes in the data lineage, or the like.

Workflow 1100 may operate on data such as documents for RAG or fine-tuning 1102 and/or database data 1104. In turn, an ingestion engine 1106 (e.g., a sub-component of feature analysis process 248) may identify the structure of the data (e.g., table, columnar, bullet, etc.). Then, at 1108, workflow 1100 may proceed by performing labeling of the structured data. Then, feature analysis process 248 may apply different row-wise data transformations with additional context of the data via the illustrated tool. In some instances, feature analysis process 248 may add the context of the data that is domain specific, which can be used later during a retrieval phase for purposes of characterization (e.g., scoring, etc.).

At 1110, workflow 1100 may create a time-based attestation of the data from at 1108. This may be stored in a row-wise format. Here, drag/drop no-code tools may be used to make rules.

At 1112, workflow 1100 may include the creation of multiple end user persona specific rules (e.g., depending on the authorization policy of a user regarding whether they should have access to the response including the data coming from a specific document). Here, drag and drop connectors created by a user may be utilized.

At 1114, workflow 1100 may include the generation and/or provision of data quality notifications. These may provide indications of which contexts, and therefore which documents, are providing the information that is not correct. Here, the rules assembled by the user may be leveraged.

At 1116, a final document may be produced for vector storage and/or fine-tuning. At 1118, outcome risk may be measured by a key performance indicator (KPI) such as an amount of security holes, outcome compliance may be measure by a key performance indicator such as the configurations matching a template, a capability product security incident response team matching may be utilized to change a key performance indicator amount of security holes, and/or a capability configuration best practices may be utilized to change the determination of the key performance indicator configurations matching a template.

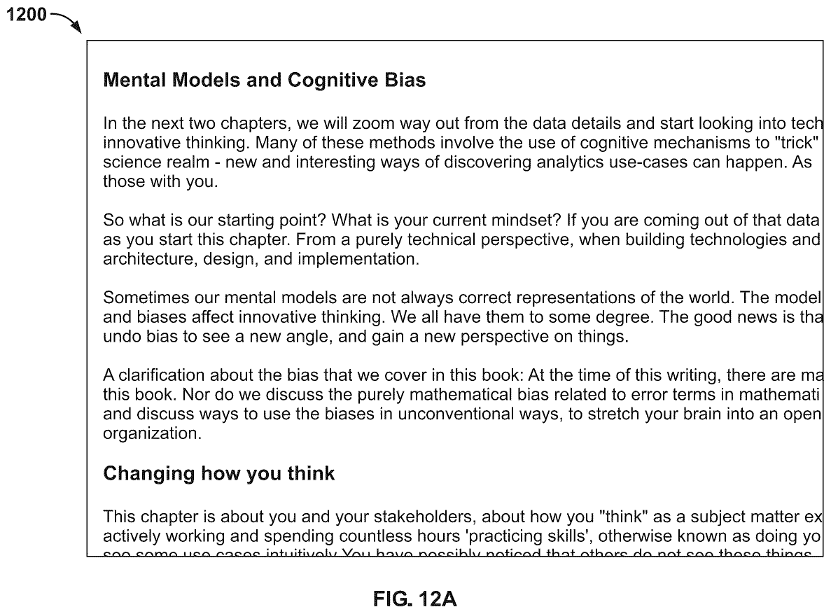

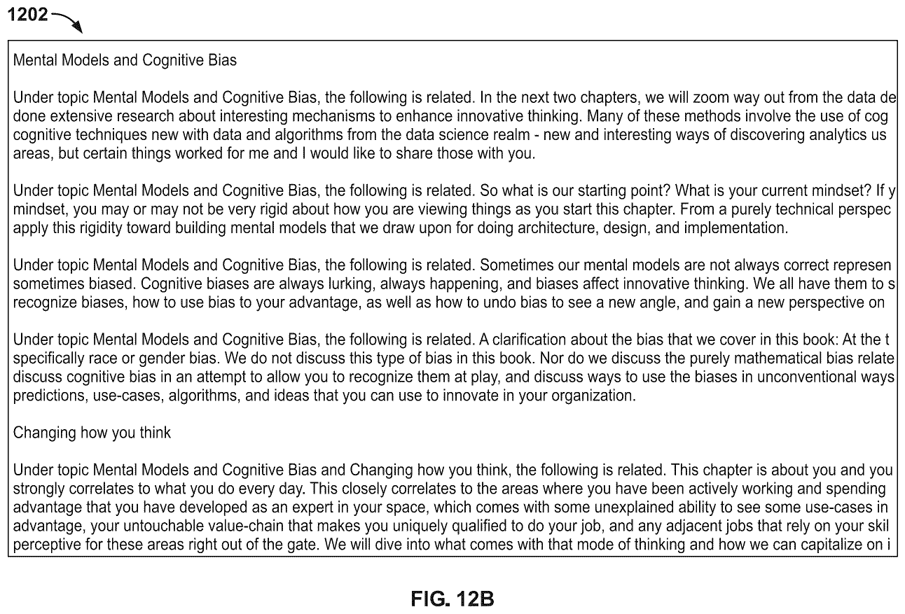

FIGS. 12A-12B illustrate an example of adding context to a raw dataset 1200 to produce a contextualized dataset 1202. Domain specific context may be added to the raw dataset 1200 via a custom data transformation. This added context in the contextualized dataset 1202 may be utilized to determine when data is going stale and/or earmarking it for automatic correction. Here, the context of the header structure can be lost. Adding header structure to each document paragraph in the vector store can keep context with chunks.

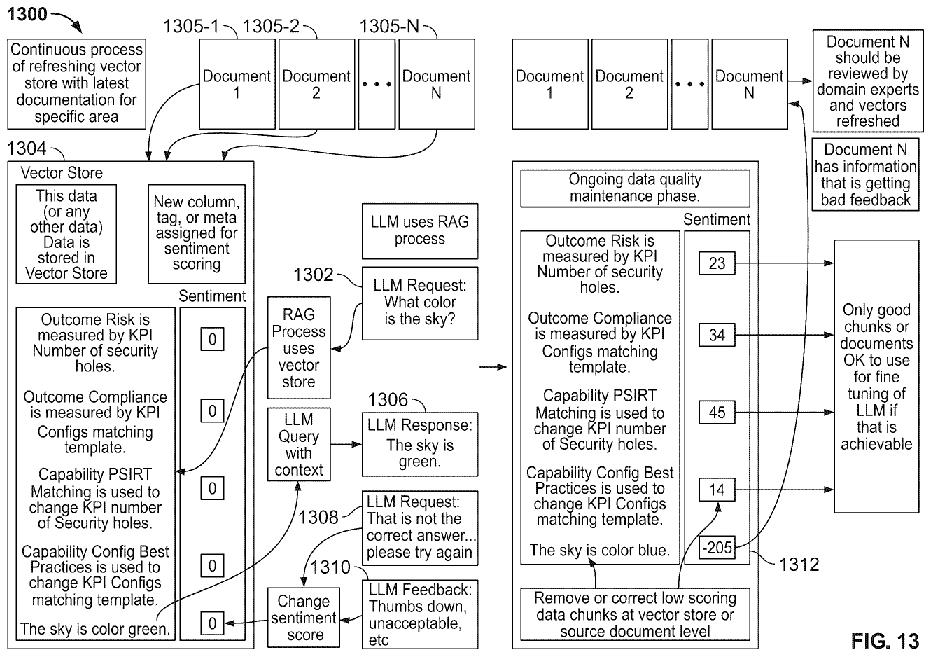

FIG. 13 illustrates an example of a procedure 1300 for adding domain-specific context at the data source and using the context to derive a chunk score, automatically. In procedure 1300, an LLM request 1302 may include a question such as “what color is the sky?” In turn, the system may leverage RAG to retrieve relevant data for the LLM request 1302 from a vector store 1304 where multiple documents 1305 had been ingested. The system assigns new columns, tags, metadata, etc. to each data chunk for sentiment scoring and other assessments in vector store 1304.

The system then enriches the LLM query with context from the vector store 1304 and generates a response 1306 that “the sky is green.” An additional LLM request 1308 or other LLM feedback 1310 may indicate that this is not the correct answer. This may lead to adjustments to the sentiment score 1312 of the related data chunks. This may then lead to a removal or correction to a low scoring data chunk at vector store 1304 or the source documentation level (e.g., flagging the particular document 1305-N that is the source for the low scoring data chunk for review by domain experts and/or vector refreshment, etc.).

In this example, “The sky is color blue” is text data which is appended to the original text data. This non-contextual presence of the data could be as a result of a.) stale data, b.) data manipulation, or c.) data corruption issue. Here, the contextual sentiment score derived for this chunk of data is “−225,” which would indicate something is wrong with this data to the retrieval phase of the RAG system. The system may also continuously or periodically monitor and/or update the sentiment scores for each data chunk.

Ultimately, in procedure 1300, only data chunks with acceptable sentiment scores are used for the fine-tuning of LLM responses. This may ensure that only high-quality, contextually accurate data is used in the RAG system to improve overall system performance and response accuracy.

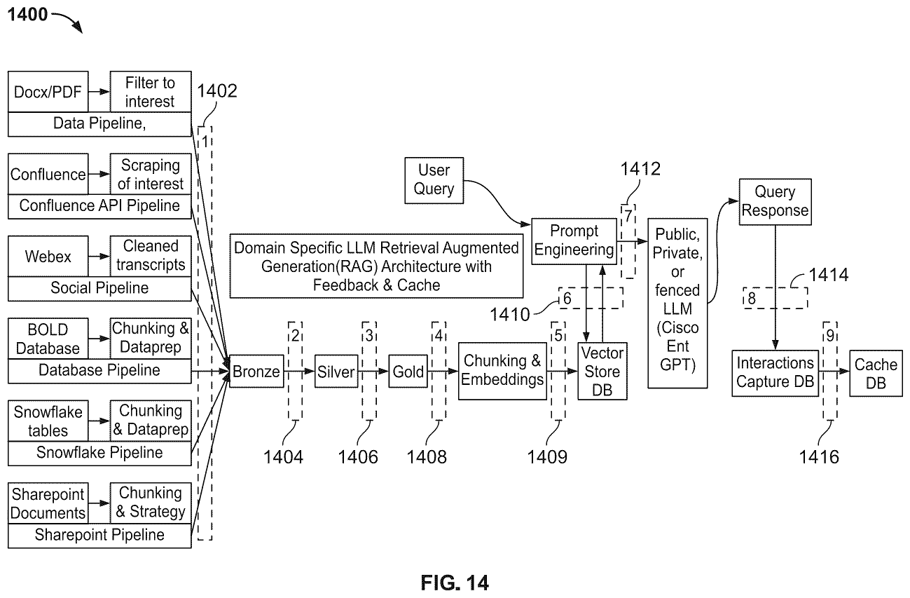

FIG. 14 illustrate an example of a data pipeline 1400 with observability operations underscoring how the scoring is done to detect and/or flag issues in an automated manner, according to various implementation. For instance, data pipeline 1400 may take place relative to a domain-specific LLM (DS-LLM). Data pipeline 1400 may be subjected to various operations and illustrate the flow of data from left to right and how the addition of domain specific contextual chunking of datasets helps in detecting and reconciling stale datasets. The illustrated data pipeline and operations may be an example implementation of a portion of a data quality assessment process (e.g., feature analysis process 248).

For example, at 1402, the system may make a determination as to what the data flowing into the system looks like. At 1404, it may use cleanup functions to prepare data and suggest updates to sources. At 1406, the system may make a determination as to what has been approved for use and who approved it (e.g., a final data source list). At 1408, it may make a determination as to what the embeddings look like and/or whether they fit within an established taxonomy.

At 1410, the system may use a create, read, update, and delete (CRUD) interface for the vector store with source data awareness. In some instances, the system may do so by using an embedding translation approach. At 1412, the system may make a determination as to what was sent to the LLM as a prompt (e.g., may include the user query). At 1414, the system may make a determination as to what the user feedback was for each query (e.g., may include the query response). At 1416, it may reconcile cache hits and queries, and make a determination as to whether the cache entries are good.

In various implementations, the data pipeline 1400 may be outfitted with any number of user interfaces. For example, data pipeline 1400 may include a user interface to examine user interactions such as what was the query at 1412, what were the context choices and engineered prompt at 1410, what was the response and user feedback to that response at 1414, what source documents were used at 1409 and at 1410. Further, the data pipeline 1400 may include a CRUD user interface to tweak the system such as by removing bad vectors at 1409 and at 1414 and associated data/docs, examining embeddings choices, removing bad cache entries at 1416, editing and/or creating data pipeline entries that should go to documents (e.g., Q&A to FAQs). Furthermore, the data pipeline 1400 may include a user interface to track documentation quality such as by identifying Q&A for FAQs at 1402, identifying data used (or not used) by the system at 1402, at 1408, and at 1414, and identifying sources associated with bad information at 1409 and at 1414.

Data pipeline 1400 may utilize the domain-specific contextual chunk added at source to create a moving scoring technique. At every stage of the data pipeline 1400, the score may be assessed, analyzed, and/or compared with the cutoff threshold values to identify if there is a potential probability of data corruption, data manipulation, data staleness, or data security threat attack in a RAG based data pipeline. In various implementations, the system could also use open-source metrics when performing scoring and score analysis, where available.

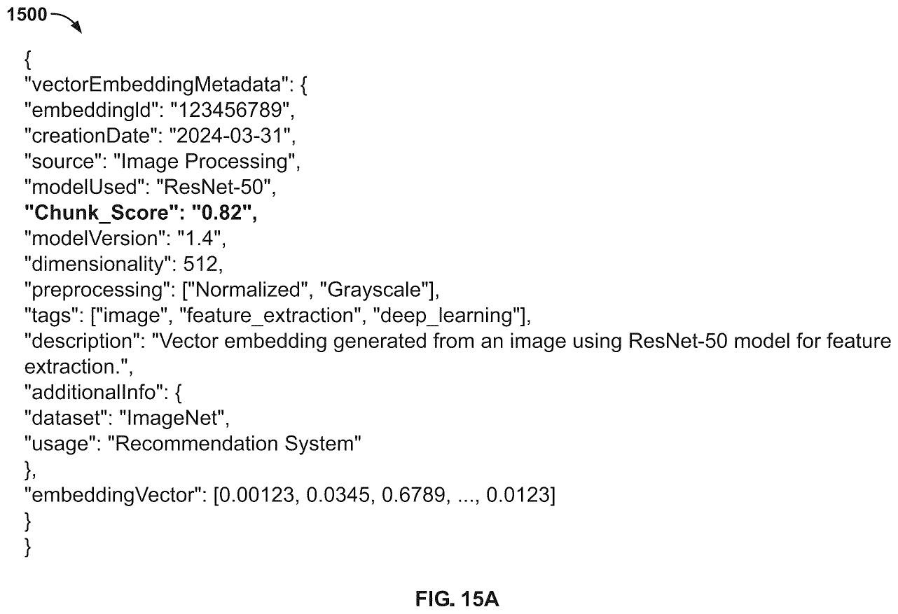

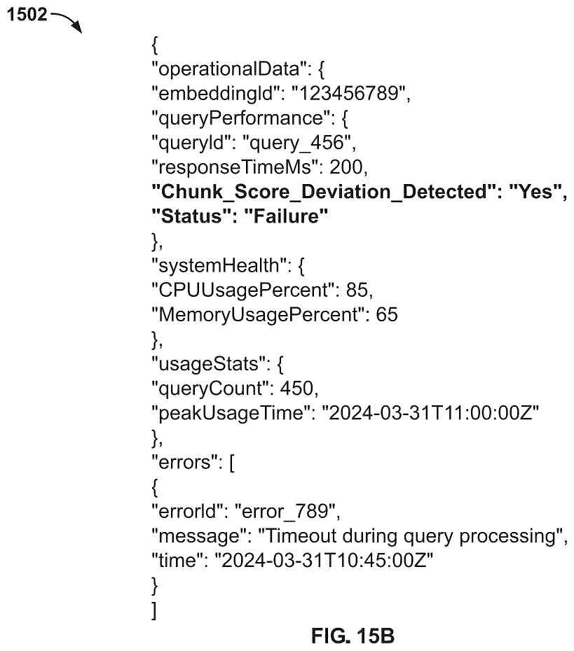

FIGS. 15A-15B illustrates examples of metadata policies providing a framework for managing and monitoring data quality and system performance in a RAG pipeline. These metadata policies may be used to monitor and/or visualize data quality across various RAG data pipeline components. Therefore, these policies may facilitate real-time monitoring and proactive management of data quality across the RAG pipeline, enhanced visualization tools that aid in identifying, analyzing, and addressing data quality issues, enhanced decision-making capabilities through access to detailed and actionable data quality insights, and integration of data quality monitoring with overall system health metrics to ensure optimal performance and reliability. These capabilities may collectively ensure that the RAG system maintains high standards of data quality, which may be crucial for delivering accurate and reliable outputs in generative AI applications.

In various implementations, by reordering or shuffling components of a few-shot prompt, ensembling techniques can also address the order sensitivity commonly found with foundation models thus improving robustness and also avoiding hallucinations by the model. Metadata typically accompanies vector embeddings when stored in the vector database; metadata associated with vector embeddings are attributes or features that describe the embeddings' context, origin or characteristics. Examples of metadata include the creation date of the embedding, input values to the embedding model to create the embedding, tags, categories, etc.

Here, the derived chunking score may be utilized during the end-to-end data traversal/data lineage (as illustrated in FIG. 14) and inserted into a JSON object to create a RAG data pipeline based meta data policy (e.g., RAG metadata policy 1500). By continuously monitoring this derived chunk score inserted into JSON object value with a graph-based visualization across the different RAG data pipeline components, the specific component which is causing the data corruption issues can be detected automatically in a large-scale RAG deployment.

In various implementations, post this detection a flag may be toggled with another JSON KVP in an operational RAG policy (e.g., RAG operational data policy 1502) to indicate that a score deviation has been detected (e.g., “Chunk_Score_Deviation Detected”=Yes). Operational data in RAG may refer to data created due to transactional processes or business operations within the database systems or connected components of the overall system infrastructure, such as applications, servers, etc. Examples of operational data generated by transactional processes may include user session data, sales transactions, real-time data, etc. Examples of operational data from business operations may include error and system logs, database usage statistics, query performance metrics, etc.

Frequently, when utilizing vector databases in RAG-based LLM and working with metadata and operational data, these additional metadata can be underutilized in conducting efficient operational queries to detect data corruptions. This can result in overlooked opportunities to optimize RAG query performance, data efficacy, improve database infrastructure, and detect critical data corruption issues before they propagate to other infrastructure components in RAG.

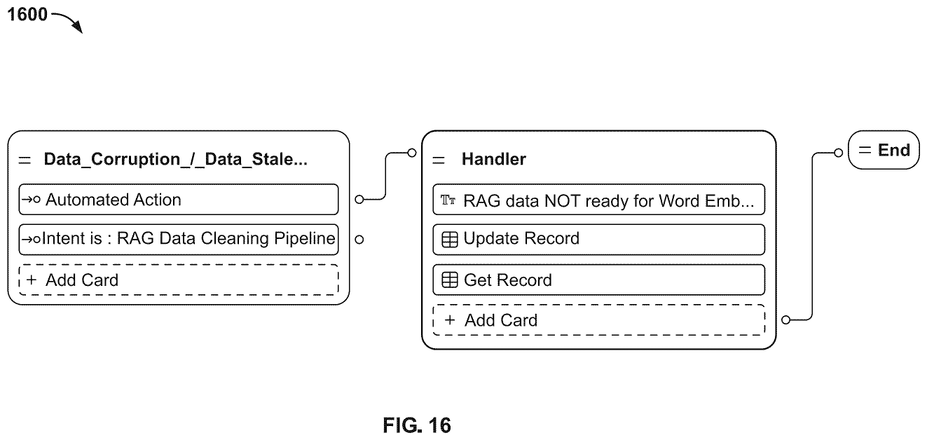

FIG. 16 illustrates an example of a user interface 1600 for RAG-based data corruption detection, chunk score derivation, and automated data cleaning pipelines specific to a data record.

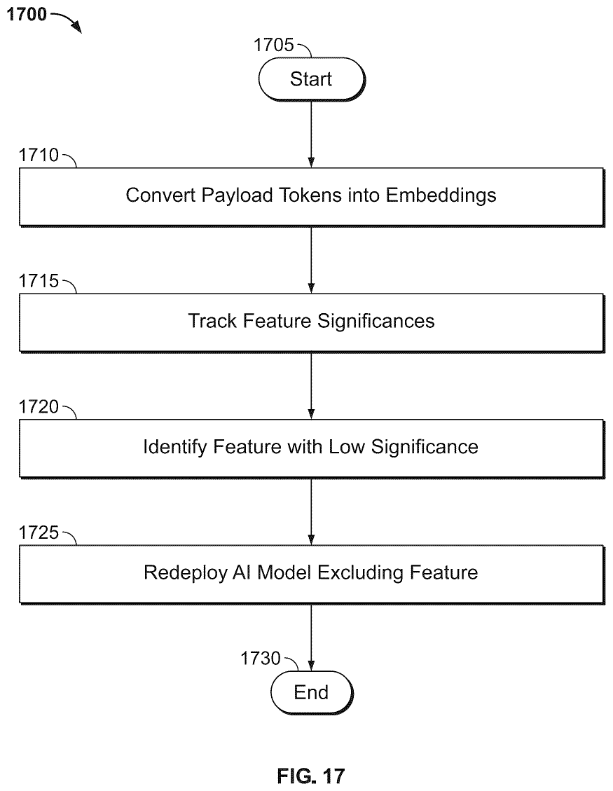

FIG. 17 illustrates an example procedure for adaptive resource and security optimization in MLaaS systems in accordance with one or more implementations described herein. For example, a non-generic, specifically configured device (e.g., device 200), may perform procedure 500 (e.g., a method) by executing stored instructions (e.g., feature analysis process 248). The procedure 1700 may start at step 1705, and continues to step 1710, where, as described in greater detail above, the device (e.g., a controller, server, etc.) may convert tokens in payloads for processing by an artificial intelligence model over time into vector embeddings. In some implementations, the artificial intelligence model is executed in a cloud-based machine learning as a service (MLaaS) system.

At step 1715, as detailed above, the device tracks, using the vector embeddings, a feature significance for each of a set of model features used by the artificial intelligence model to process the payloads. In some implementations, the device may also make a security threat assessment of the vector embeddings of the payloads to identify an embedding-related security threat attack. In further implementations, the device may further make a data quality assessment of the vector embeddings of the payloads, prior to the artificial intelligence model processing them. In one implementation, the device maintains the feature significance of each of the set of model features in a table. In such cases, the device may also rank the feature significance of each of the set of model features in the table.

At step 1720, the device identifies a particular feature in the set of model features whose feature significance has dropped below a threshold, as described in greater detail above. In some implementations, the device may do so by using an anomaly detection model on a timeseries of the feature significance of the particular feature. In some instances, the device may also adjust the threshold over time based on a resource consumption of the artificial intelligence model.

At step 1725, as detailed above, the device redeploys the artificial intelligence model with a reduced feature set that excludes the particular feature. In some implementations, the device redeploys the artificial intelligence model with the reduced feature set that excludes the particular feature in part based on a resource utilization cost associated with the particular feature. In one implementation, the device may do so by retraining the artificial intelligence model.

Procedure 1700 may then end at step 1730.

It should be noted that while certain steps within procedure 1700 may be optional as described above, the steps shown in FIG. 17 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for adaptive resource and security optimization framework for machine learning as a service (MLaaS) systems, as well as for data quality observability for retrieval augmented generation (RAG) based generative artificial intelligence, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
converting, by a device, tokens in payloads for processing by an artificial intelligence model over time into vector embeddings;
tracking, by the device and using the vector embeddings, a feature significance for each of a set of model features used by the artificial intelligence model to process the payloads;
identifying, by the device, a particular feature in the set of model features whose feature significance has dropped below a threshold; and
redeploying, by the device, the artificial intelligence model with a reduced feature set that excludes the particular feature.

2. The method as in claim 1, wherein the artificial intelligence model is executed in a cloud-based machine learning as a service (MLaaS) system.

3. The method as in claim 1, further comprising:
making a security threat assessment of the vector embeddings of the payloads to identify an embedding-related security threat attack, prior to the artificial intelligence model processing them.

4. The method as in claim 1, wherein identifying the particular feature whose feature significance has dropped below a threshold comprises:
3 using an anomaly detection model on a timeseries of the feature significance of the particular feature.

5. The method as in claim 1, wherein the device redeploys the artificial intelligence model with the reduced feature set that excludes the particular feature in part based on a resource utilization cost associated with the particular feature.

6. The method as in claim 1, wherein redeploying the artificial intelligence model comprises:
retraining the artificial intelligence model.

7. The method as in claim 1, further comprising:
making a data quality assessment of the vector embeddings of the payloads, prior to the artificial intelligence model processing them.

8. The method as in claim 1, further comprising:
adjusting the threshold over time based on a resource consumption of the artificial intelligence model.

9. The method as in claim 1, further comprising:
maintaining the feature significance of each of the set of model features in a table.

10. The method as in claim 9, further comprising:
ranking the feature significance of each of the set of model features in the table.

11. An apparatus, comprising:
one or more network interfaces;
a processor coupled to the one or more network interfaces and configured to execute one or more processes; and
a memory configured to store a process that is executable by the processor, the process when executed configured to:
convert tokens in payloads for processing by an artificial intelligence model over time into vector embeddings;
track, using the vector embeddings, a feature significance for each of a set of model features used by the artificial intelligence model to process the payloads; 10
identify a particular feature in the set of model features whose feature significance has dropped below a threshold; and 12
redeploy the artificial intelligence model with a reduced feature set that excludes the particular feature.

12. The apparatus as in claim 11, wherein the artificial intelligence model is executed in a cloud-based machine learning as a service (MLaaS) system.

13. The apparatus as in claim 11, wherein the process when executed is further configured to:
making a security threat assessment of the vector embeddings of the payloads to identify an embedding-related security threat attack.

14. The apparatus as in claim 11, wherein the apparatus identifies the particular feature whose feature significance has dropped below a threshold by:
using an anomaly detection model on a timeseries of the feature significance of the particular feature.

15. The apparatus as in claim 11, wherein the apparatus redeploys the artificial intelligence model with the reduced feature set that excludes the particular feature in part based on a resource utilization cost associated with the particular feature.

16. The apparatus as in claim 11, wherein the apparatus redeploys the artificial intelligence model in part by:
retraining the artificial intelligence model.

17. The apparatus as in claim 11, wherein the process when executed is further configured to:
make a data quality assessment of the vector embeddings of the payloads, prior to the artificial intelligence model processing them.

18. The apparatus as in claim 11, wherein the process when executed is further configured to:
adjust the threshold over time based on a resource consumption of the artificial intelligence model.

19. The apparatus as in claim 11, wherein the process when executed is further configured to:
maintain the feature significance of each of the set of model features in a table.

20. A tangible, non-transitory, computer-readable medium storing program instructions that cause a device to execute a process comprising:
converting, by the device, tokens in payloads for processing by an artificial intelligence model over time into vector embeddings;
tracking, by the device and using the vector embeddings, a feature significance for each of a set of model features used by the artificial intelligence model to process the payloads;
identifying, by the device, a particular feature in the set of model features whose feature significance has dropped below a threshold; and
redeploying, by the device, the artificial intelligence model with a reduced feature set that excludes the particular feature.
